(19) United States
(12) Patent Application Publication
(10) Pub. No.: US 2021/0357386 A1
(43) Pub. Date: Nov. 18, 2021

(54) METHOD FOR SPLIT-LEDGER INVENTORY AND ACTIVITY TRACKING

(71) Applicant: AT&T Intellectual Property I, L.P., Atlanta, GA (US)

(72) Inventors: James Pratt, ROUND ROCK, TX (US); Lars Johnson, Brooklyn, NY (US); Eric Zavesky, Austin, TX (US)

(73) Assignee: AT&T Intellectual Property I, L.P., Atlanta, GA (US)

(21) Appl. No.: 16/874,731

(22) Filed: May 15, 2020

(51) Int. Cl. G06F 16/23; G06F 21/62; G06F 3/14

(52) U.S. Cl. CPC G06F 16/2379; G06Q 10/087; G06F 3/1454; G06F 21/6218

(57) ABSTRACT

Aspects of the subject disclosure may include, for example, storing, in the memory a passed ledger, where the passed ledger includes data associated with characteristics of an object and wherein there is a one-to-one association between the passed ledger and the object. Some embodiments further include receiving, at a device including the processing system, information about a change to a characteristic of the object and writing to the passed ledger a block of data. The block of data is based on the change to the characteristic of the object. Some embodiments further include generating a hash of contents of the passed ledger, storing the hash of the contents of the passed ledger in a hash ledger and communicating, by the device, the hash of the contents of the passed ledger to a remote device. Other embodiments are disclosed.

### FIELD OF THE DISCLOSURE

The subject disclosure relates to a method and apparatus for split-ledger inventory and activity tracking.

### BACKGROUND

Video immersion systems or media immersion systems allow a user to encounter an intensified media experience using video, audio, haptics and other sensory stimuli. Such immersion systems may be referred to as enhanced or extended reality (XR), augmented reality (AR) or, collectively, XR systems. XR systems provide content with enhanced video and audio to alter and improve user experience. XR systems may further be adapted to allow a user to interact with virtual objects, real world objects, or a combination of these. However, such interactions may cause modifications to virtual or real world objects and the modifications must be tracked and accounted for over time and among users.

### BRIEF DESCRIPTION OF THE DRAWINGS

Reference will now be made to the accompanying drawings, which are not necessarily drawn to scale, and wherein:

FIG. 1 is a block diagram illustrating an example, non-limiting embodiment of a communications network in accordance with various aspects described herein.

FIG. 2A is a block diagram illustrating an example, non-limiting embodiment of an augmented reality (AR) system functioning within the communication network of FIG. 1 in accordance with various aspects described herein.

FIG. 2B illustrates an example use of a cryptographic ledger system for tracking a virtual object in accordance with various aspects described herein.

FIG. 2C is an illustrative embodiment of a method in accordance with various aspects described herein in accordance with various aspects described herein.

FIG. 2D is an illustrative embodiment of a passed ledger and an associated hash ledger in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for tracking items in augmented reality environments. Other embodiments are described in the subject disclosure.

In augmented reality systems, objects may have a location and characteristics and ownership. Tracking an object may involve maintaining a record of each aspect, location, characteristics, and ownership, and updating those aspects as they change over time. There are generally two ways of keeping track of things. One is, where is a specific item, or what specific item is in a place? In this example, a computer system keeps track of a place or location and what item is in that location. In an augmented reality environment, a computer system must behave differently because there are too many possible spaces that may be occupied by an object. To identify and characterize an object in the virtual environment, the augmented reality computer system must repeatedly poll ever location to determine if there is an object in that location. If an object is located at a location, the augmented reality computer system must further determine characteristics of the object, characteristics such as what it is, who owns it, how is it oriented, whether it has edges, whether those edges align with other objects, etc.

This process of polling locations in the virtual space represents a substantial technological problem for a processing system. Tracking items, characteristics and ownership for the many locations in an augmented reality system may require unmanageable amounts of memory and processing power. Additionally, as augmented reality systems are created with increased distribution both in geography (diverse computational hosting sites throughout the world) and administration (owned and operated by entities of various sizes and operational authorities), the trusted coordination of objects must receive explicit attention. Further, tracking these features for multiple objects in real time or substantially in real time may be difficult or impossible, even if sufficient processing power and memory are available. The computational challenge is substantial.

The second way of keeping track of items and objects is to poll every object in the augmented reality environment. Instead of determining “what is in this space in the environment,” the augmented reality computer system must determine which objects are present currently and where is object 1, where is object 2, etc., what is their orientation and other characteristics? In effect, a default condition for the environment is that nothing is present in any location unless a participant or other source states that an object is there, and defines its characteristics. This technique reduces system requirements for the augmented reality computer system, including reducing the amount of memory required for data storage, reducing the processing power required to process data, and enabling more rapid reaction to changing conditions in the augmented reality environment.

While exemplary embodiments are described in connection with an augmented reality or virtual reality video game, the principles and features described herein may be extended to any augmented or virtual environment including, for example, a factory environment. In a factory environment, augmented reality features may be used to determine locations, ownership and characteristics of tools or components or assemblies or other factory elements.

One or more aspects of the subject disclosure include a processing system and a memory that stores executable instructions that, when executed by the processing system, facilitate performance of operations. In some embodiments, the operations include storing, in the memory a passed ledger, where the passed ledger includes data associated with characteristics of an object and wherein there is a one-to-one association between the passed ledger and the object. Some embodiments further include receiving, at the processing system, information about a change to a characteristic of the object and writing to the passed ledger a block of data. The block of data is based on the change to the characteristic of the object. Some embodiments further include generating a hash of contents of the passed ledger, storing the hash of the contents of the passed ledger in a hash ledger and communicating, by the device, the hash of the contents of the passed ledger to a remote device.

One or more aspects of the subject disclosure include a machine-readable medium including executable instructions that, when executed by a processing system including a processor, facilitate performance of operations including establishing an augmented reality environment in a server system accessible by a plurality of remote devices of participants in the augmented reality environment. Some embodiments further include creating an object in the augmented reality system, including creating a virtual object and assigning to the virtual object a plurality of characteristics, a location and ownership. Some embodiments further include creating for the object a passed ledger configured to store data associated with the characteristics, the location and the ownership of the object and wherein there is a one-to-one association between the passed ledger and the object. Some embodiments further include receiving, by the server system, an indication of a modification to one of a characteristic, the location and the ownership of the object, writing to the passed ledger a block of data based on the change to the characteristic, the location or the ownership of the object, and communicating by the server system a hash of contents of the passed ledger to remote devices of the plurality of remote devices to inform the remote devices about the change in characteristic, the location or the ownership without communicating the entire passed ledger.

One or more aspects of the subject disclosure include a method including establishing, by a processing system including a processor and a memory, an augmented reality environment, wherein the processing system is accessible over a communication network by a plurality of remote devices of participants in the augmented reality environment. Some embodiments further include creating an object in the augmented reality system including creating a virtual object and assigning to the virtual object a plurality of characteristics. Some embodiments further include storing data in a passed ledger in the memory, wherein the stored data is associated with at least one characteristic of the plurality of characteristics of the virtual object. Some embodiments further include receiving, by the processing system, a communication over the communication network from a remote device of the plurality of remote devices, where the communication includes information about a modification to the at least one characteristic the object. Some embodiments further include writing to the passed ledger a block of data based on the modification to the at least one characteristic of the object, generating a hash of contents of the passed ledger, communicating the hash of the contents of the passed ledger to the plurality of remote devices to inform the plurality of remote devices about the modification to the at least one characteristic without communicating the entire passed ledger.

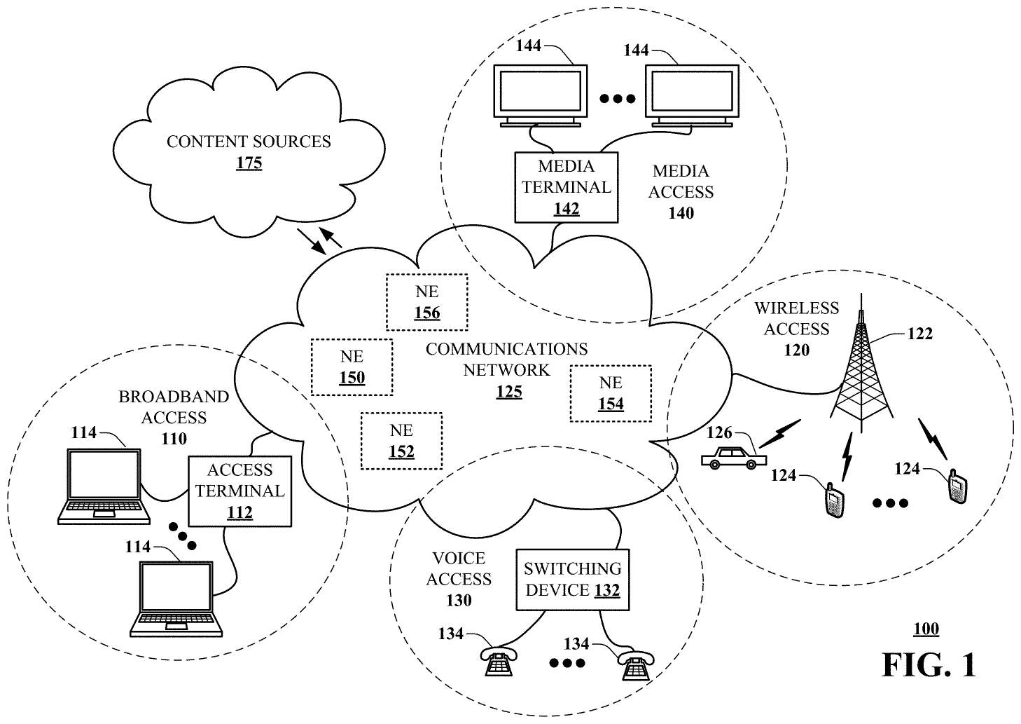

Referring now to FIG. 1, a block diagram is shown illustrating an example, non-limiting embodiment of a system 100 in accordance with various aspects described herein. For example, system 100 can facilitate in whole or in part an augmented reality system including a server at a network element and accessible by remote devices at other network elements. The augmented reality system associates a passed ledger with an object and records blocks of information about events of the object in the passed ledger. At times, a hash is made of the data in the passed ledger and communicated to remote devices participating in the augmented reality system. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

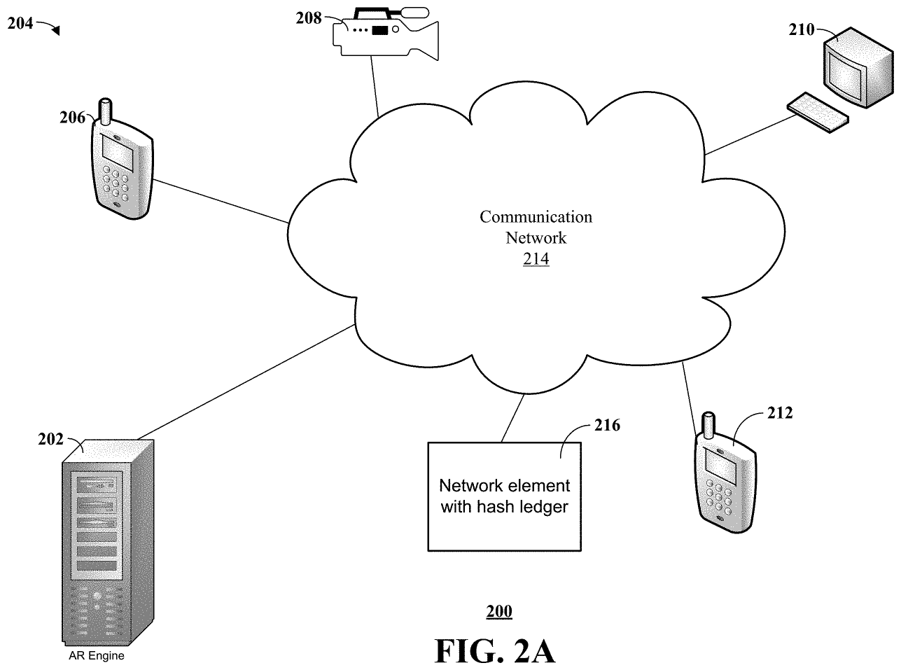

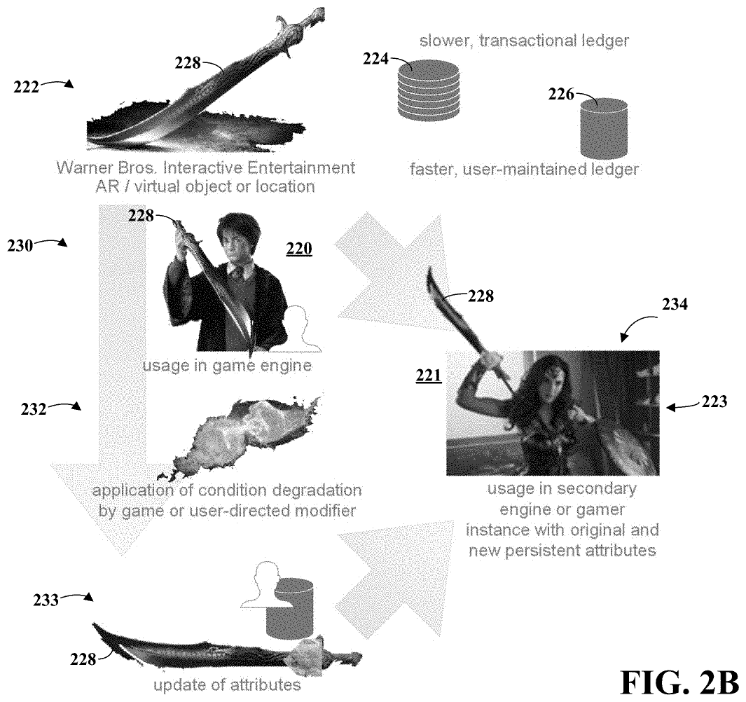

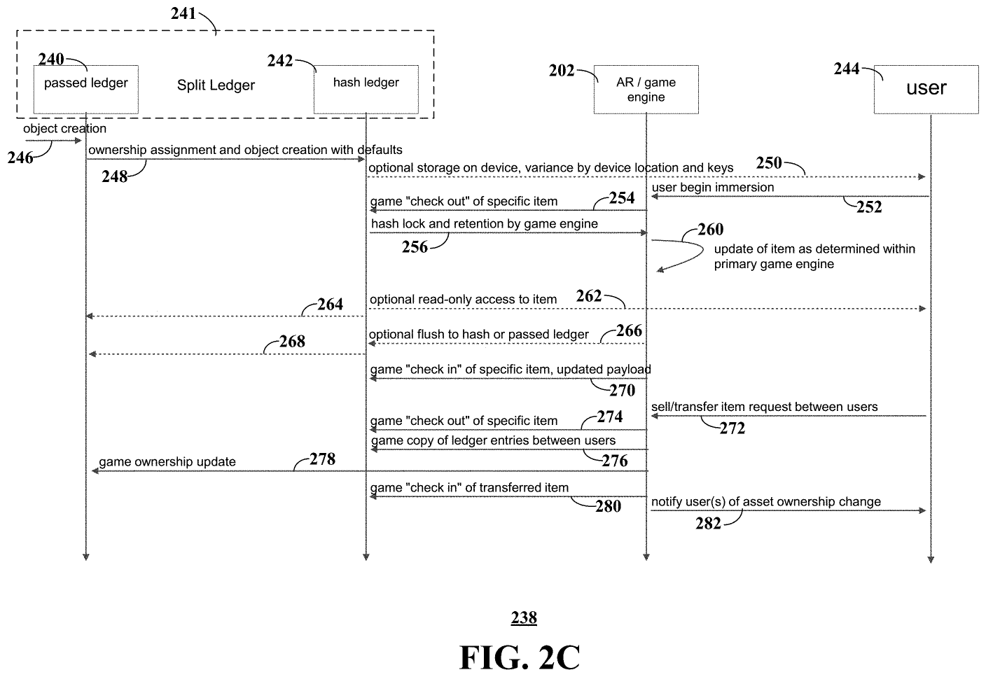

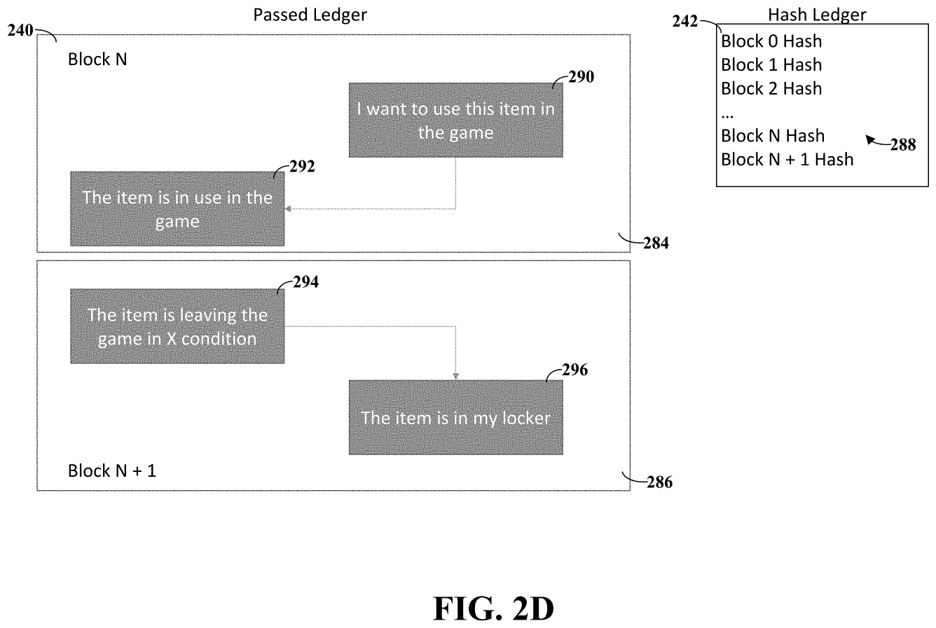

FIG. 2A is a block diagram illustrating an example, non-limiting embodiment of an augmented reality (AR) system 200 functioning within the communication network 125 of FIG. 1 in accordance with various aspects described herein. The AR system 200 in the exemplary embodiment includes an augmented reality (AR) engine 202, one or more remote devices 204 including a mobile device 206, a video imaging system such as video camera 208, a desktop computer 210, a portable device 212 and one or more network elements 216 that may include a cryptographic hash ledger. The AR engine 202 and the remote devices 204 communicate over a communication network 214. The communication network 214 may include any of the features of the communications network 125 described in conjunction with FIG. 1 including wireline and wireless networks, and combinations of these. The communication network 214 may conduct transactions with entities including the AR engine 202, the remote devices 204 and the network element 216 including providing AR media or XR media, reporting interactions with real and virtual objects and use of a blockchain ledger to record transactions.

The AR engine 202 implements an augmented reality system which may be referred to as an AR system, an XR system, or by other terminology. The AR engine 202 receives information over communication network 214 from the remote devices 204. Generally, the AR engine 202 receives sensory information including video information and sound information from the remote devices 204. Similarly, the AR engine 202 provides information including video information, audio information and haptic information to the remote devices 204 over the communication network 214. The video information, sound information and haptic information may be encoded in any suitable manner for communication over the communication network 214.

The AR engine 202 controls an AR environment which is accessible by any of the remote devices 204, including combinations of the remote devices 204. In some embodiments, a game engine may be local to one or more of the user devices 204, with game operation and interaction shared over the communication network 214. Users of the remote devices 204 may participate in the AR environment using the remote devices 204. Users in some embodiments may participate in the AR environment by controlling actions of an avatar to interact with other avatars and objects in the AR environment. The AR environment may include one or more virtual objects and one or more virtual rooms. Virtual objects include objects having properties under control of the AR engine 202 and under control of participants in the environment using the remote devices 204. The AR engine 202 receives from the remote devices 204 information about interactions with the virtual objects. The users, by means of avatars or other means, may modify the virtual objects. The AR engine 202 monitors and stores information about the interactions and modifications to the virtual objects and the virtual rooms. Virtual object may be located in and moved among virtual rooms of the AR environment. In general, the AR engine 202 receives information about user manipulations of virtual objects, and the AR engine 202 provides to the remote devices 204 information about the virtual objects, including manipulations and alterations of those objects.

In some embodiments, the AR engine 202 may implement a virtual environment or AR environment for tracking real-world objects. In an example, an assembly line for manufacturing equipment may use AR engine 202 to track items including components for assembly. The AR engine 202 may track, for example, the number of items, such as screws, and their locations. The AR engine 202 could monitor, for example, the number of screws remain available for assembly in order to replace them as necessary. The tracked information may include the number of screws, a description or model number of the screws, location of the screws, etc. The AR engine 202 may track other real, physical components in other types of systems, as well.

In some embodiments, the AR engine 202 may implement multiple virtual environments or AR environments. Each respective AR environment may have its own set of virtual rooms and virtual objects. Users may access one, some or all AR environments implemented by the AR engine 202, depending on permissions and credentials and other factors. Further, in accordance with some embodiments, users may navigate between multiple AR environments using the same or different avatars. Moreover, in some embodiments, the users may take possession or ownership of an object in one AR environment, and use and modify that object, and move to another AR environment and the object and its characteristics will persist, along with the user's possession of the object.

The remote devices 204 include any number of devices that may interact with the AR engine 202. In the example of FIG. 2A, the remote devices 204 include a mobile device 206, a video camera 208, a desktop computer 210 and a portable device 212. The remote devices 204 illustrated in FIG. 2A are intended to be exemplary only. Other embodiments will have differing groups of remote devices 204 and the number and variety of remote devices interacting with the AR engine 202 will vary over time. Some of the remote devices 204 may be combined with other components. For example, the video camera 208 may be incorporated in an XR headset to be worn by a user. The video camera 208 captures images in the vicinity of the user and the headset, and the headset includes one or more display devices for presenting XR media to the user wearing the headset. In general, each of the remote devices 204 includes an image capture system such as a camera, a processing system including one or more processors, a memory adapted to store instructions and data for use by the processing system, a communication interface enabling communication such as communication over the communication network 214 and a user interface.

The AR system 200 in some embodiments implements a media immersion system. The media immersion system allows a user, such as a user of one of the remote device 204, to encounter an intensified media experience using video, audio, haptics and other sensory stimuli. The remote devices 204 enable users to see, hear and otherwise sense media under control of the AR engine 202. In some embodiments, the remote devices 204 enable users of the remote devices to experience and interact with and change virtual objects. Also in some embodiments, the remote devices 204, in conjunction with the AR engine 202, enable users of the remote devices 204 to experience and interact with real objects, such as real objects located with one of the remote devices or maintained by a user of one of the remote devices.

The network element 216 implements a cryptographic ledger system for maintaining history and ownership of real and virtual objects within the AR system 200. In some embodiments, the AR system 200 operates in conjunction with a split ledger system including a passed ledger and a hash ledger. The passed ledger is associated with a virtual object. The passed ledger is maintained by each subsequent owner of the object. Modifications to the object or activities with the object are recorded as blocks stored in the passed ledger. Only the AR engine 202 or a device of the user who is the owner of the passed ledger can write new blocks to the passed ledger. When ownership of the object is transferred, the passed ledger is passed to the new owner with a partial final block. The new owner proposes a completed block to the current owner who may approve the block, completing transfer of ownership. The new owner is then able to record in the passed ledger future activities with the object. The former owner no longer has access to the current passed ledger. Participants in the AR system 200 who do not own the object only can see the hash ledger. This maintains a level of privacy and security for users of the AR system 200. The passed ledger is a private ledger in that the current owner can choose who can see the complete ledger, however any previous owner may retain and share a partial copy of the ledger as was complete during the time they were the owner. The hash ledger is a public ledger in that a read only copy may be requested by any party at any time.

As immersion requirements in XR systems grow, personalization of virtual objects and the history of those personalizations of virtual objects are needed to maintain immersion. Combining public and private ledgers provides a rapid and efficient way to track changes across digital platforms. The virtual object ecosystem has splintered to create challenging marketplaces for buying, selling or trading virtual objects, including security and privacy threats. In general, these same problems exist in multiple environments. Examples include supply chain management as well as in tracking virtual education and personal achievements. Use of public and private ledgers with virtual objects provides a solution to issues of tracking ownership transfer of information and items, modifications to items and security and privacy issues.

Use of a cryptographic ledger system provides an accessible, public tool for tracking historical information that can be seen by other applications. Moreover, cryptographic ledger systems provide persistence and security and provide timing order information, for example through use of timestamps. Cryptographic ledger systems thus may have application to XR systems including AR system 200.

FIG. 2B illustrates an example use of a cryptographic ledger system for tracking a virtual object. FIG. 2B shows an AR environment including a first AR environment 220 and a second AR environment 221 as implemented by the AR engine 202 of FIG. 2A. In the first AR environment 220, a user participates in a first virtual reality game 222. In the second AR environment 22, the user participates in a second virtual reality game 223. The user participates in the first virtual reality game 222 and the second virtual reality game 223 using one of the remote devices 204, such as video camera 208 wherein the video camera 208 is incorporated in an XR headset worn by the user.

In the example of FIG. 2B, a cryptographic ledger system is implemented as a split ledger. A first memory 224 maintains a transactional ledger and may be a traditional blockchain or other type of cryptographic data structure. It keeps track of the items and their availability at a higher level. A second memory 226 maintains a passed ledger. The passed ledger holds much more detailed information about the status of the item. The first memory 224 may be implemented, for example, by the network element 216 with the hash ledger in FIG. 2A. The network element 216 may be a standalone device, may be functionally incorporated in the AR engine 202, or may be maintained elsewhere. The second memory 226 may be part of respective remote devices 204 and may be passed from one of the remote devices 204 to another as ownership of a tracked object changes during operation of the AR system 200 to implement the virtual reality game 222.

In the virtual reality game 222, at game time 230, a character in the game interacts with an object such as a sword 228. In the context of the virtual reality game 222, the sword 228 has certain characteristics such as a power or strength. The characteristics may vary over time, under control of the AR engine 202 implementing the virtual reality game 222. For example, the capabilities of the sword 228 may be diminished and replenished. The character may be, for example, an avatar in the virtual reality game 222 and may be under control of a user of one of the remote devices 204 interacting with the AR engine 202. When the character picks up the sword 228, a block is added to a passed ledger to indicate that the character or user now has possession of the sword 228. The block is added to the passed ledger by writing data to the second memory 226, either by the user device of the user or by the AR engine 202, along with other necessary identification information and timestamp information. During the game, at game time 232, some degradation of the capabilities of the sword 228 occurs. The degradation is recorded as an additional block in the ledger at game time 232, with suitable timestamp information. This may be done upon returning the item to the possession of the user. During game play, the AR engine 202 controls and updates the asset. Each change need not be reflected in a new block, simply the state of the asset upon entering the game and upon leaving or at a key point such as change in ownership status or a “save point.” Subsequently, possession or ownership of the sword 228 within the first virtual reality game 222 is passed to another user. The change of ownership or possession is recorded as an additional block in the ledger at game time 234.

If the local user or remote device is modifying the object, it may not need to update the global ledger maintained by the first memory 224. Only the split ledger in the second memory 226 needs to be updated. The hash ledger 242 needs to be updated only if the object is removed from the virtual reality game 222 or if possession or ownership of the object, the sword 228, changes. The split ledger including the hash ledger and the passed ledger provides storage of virtual reality details which is persistent and has time-stamped state conditions, and may also be updated in near-real time, such as during a fast-changing virtual reality environment.

At game time 233, possession of the sword 228 transfers from one character to another. This may occur due to actions within virtual reality game 222 or due to actions of users participating in the game, or for any other reasons. Responsive to this transfer of possession, at game time 233, the passed ledger associated with the sword 228 is updated with all attributes of the sword by writing to the passed ledger a block with appropriate data. Further, ownership is updated by writing to the passed ledger a block with data indicating the change in ownership. The hash ledger is updated as well to reflect the change in ownership. A hash operation is performed on the contents of the new block in the passed ledger and a hash value is generated. The hash value is written to the hash ledger in the memory 224.

In some embodiments, for each object in a virtual environment such as the virtual reality game 222, there is a passed ledger which maintains all the details of the object. The details are written as a series of block to the passed ledger whenever an event or occurrence happens for the object that should be recorded. The owner of the object within the virtual environment owns the passed ledger and the passed ledger operates as a private ledger. Separately, the hash ledger serves as a public ledger but only contains a series of hash values which are generated from a hash of block of the passed ledger.

At game time 234, the sword 228 is moved to the second virtual reality game 223. The second virtual reality game 223 is part of the second AR environment 221 as implemented by the AR engine 202. The second AR environment 221 is independent of the first AR environment 220. The second AR environment 221 generally includes different avatars and characters, different objects and different rooms from the first AR environment 220. However, the sword 228 is transferred from the first AR environment 220 to the second AR environment 221. This is achieved by use of the passed ledger associated with the sword 228. For example, a block may be written to the passed ledger to record that the sword was removed from the first AR environment 220 to the possession of the owner, then entered into gameplay of the second AR environment. The data contained in the block contains all information necessary to record each change of state, including identification information for the sword 228, identification information for the first AR environment 220 and the second AR environment 221, and any changes to the sword 228 or its characteristics.

The passed ledger retains all data in the blocks which define the history of the sword 228. The passed ledger retains the history of the sword 228. The retained data includes, for example, information about characteristics or attributes of the sword. Thus, the degradation of the capabilities of the sword 228 which was recorded as a block in the passed ledger is retained in the passed ledger. When the sword 228 is used in the second virtual reality game 223, the sword is subject to the same degradation. The passed ledger thus provides permanence for features of objects such as the sword, including characteristics, ownership and location. The passed ledger thus provides heterogeneous, cross-system communication. That is, different gaming platforms may communicate properties of a persistent object equally, using the passed ledger to store and communicate those properties and their accumulated history. The object may be created in a first gaming platform and transferred to a different gaming platform. Examples of such gaming platforms include Xbox®, Playstation®, and Nintendo® gaming systems. Other gaming platforms include online systems such as those offered by Warner Media. The passed ledger may be shared or transferred among such gaming platforms to make an object such as the sword 228 portable among the gaming platforms.

A split ledger arrangement including the passed ledger and the hash ledger may be particularly applicable to transactions in an AR environment between a buyer and a seller. They are the only two participants who need to agree to the details of an object of a transaction. If the seller can prove that everything the seller asserts about the object is correct, the buyer will value the object and the transaction more. Preferably, some third party has access to factual information as proof of the seller's assertion. If the seller gives the third party just the hash of the factual information, the third party can readily store the hashed information, the stored information does not require a lot of storage space and it can be readily shared with others if needed. Further, it does not include any personally identifiable information (PII) because it is just a hash of the transaction information.

Similarly, in the case of an XR system such as AR system 200 or another virtual application, the cryptographic ledger system may be used to prove that an event actually happened to a virtual object without making public the details of the event that happened. The virtual game user and the AR engine 202 agree on the details, those are recorded in the hash value of the block for the object with a time stamp for the time of the transaction. That hash value is reported to other game participants, such as other remote devices. From then on, any participant with access to the block for that time can prove that it was correct at the time. Thus, the system shares non-important information, in the form of the hash, which proves the important details of the transaction.

The AR engine 202 operates as a game engine that controls the current state of the first virtual reality game 222 and the second virtual reality game 223. When an object such as the sword 228 is checked in to the game engine, any changes or modifications to the object are recorded in a passed ledger file associated with the object by the AR engine 202. The current state of the item is shared with all participants engaged in the AR engine 202.

FIG. 2C is an illustrative embodiment of a method 238 in accordance with various aspects described herein. FIG. 2C illustrates interactions that may occur, for example, in the AR system 200 of FIG. 2A or in the first AR environment 220 of FIG. 2B. Not all communications or actions are shown in FIG. 2C so as to not unduly complicated the drawing figure.

In the illustrated example, a cryptographic ledger system includes a split ledger 241. The split ledger 241 includes a passed ledger 240 and a hash ledger 242. The AR engine 202 interacts with a user 244. The user 244 may operate, for example, one of the remote devices 204 of FIG. 2A to participate in a virtual environment such as virtual reality game 222 of FIG. 2B. In other embodiments, other virtual systems may be operated in the manner shown, including a factory which has tools and components to be tracked, an education system or a supply chain, or others.

At step 246, upon initiation of an application, an object is created. The application may be a virtual reality game such as virtual reality game 222 or a system for tracking items or any other suitable system where monitoring objects may be of value. Generally, the application may be implemented on a processing system including one or more processors and a memory and including a communication interface for network communications with other devices. In the example of FIG. 2C, the object may be created in a virtual environment of a group of virtual environments which are created and maintained by the AR engine 202. In general, every object of interest in the virtual environment has an associated passed ledger and an associated hash ledger.

The object or item created at step 246 is trackable in that it has attributes or characteristics that may vary over time and which can be detected or monitored by the AR engine 202. The characteristics may include location of the object and attributes of the object such as color, size, strength or weakness or other attributes. The characteristics may be physical in nature, relating to sense-able features such as color, mass, sound, texture and so on. The characteristics may be other than physical, such as some power or capability. The characteristics associated with an item are related to the nature of the item and the nature of the virtual reality system. Creating the object at step 246 may include establishing for the object one or more characteristics, a location, ownership or possession, and other suitable attributes.

When the object is created at step 246, a passed ledger 240 and a hash ledger 242 are created for the object. In some embodiments, there is a one-to-one association between the passed ledger 240 and the object and between the hash ledger 242 and the object. That is, in some embodiments, for every object, there is an associated passed ledger and an associated hash ledger. In some embodiments, only a participant in the AR environment who actually has possession of the object may write to the passed ledger associated with the object. The participant hands ownership of the passed ledger to the AR engine 202, meaning the AR engine 202 is the current owner, and may create additional blocks where it passes an update to itself. The passed ledger 240 includes the individual object's history. Events and modifications to the object accumulate in the historical information contained in the passed ledger 240. As events and modifications to the object occur, subsequent blocks are written to the passed ledger recording the history of the object. The passed ledger 240 is a living document that accrues blocks and may have a tree structure as it creates forks over time as ownership is exchanged. However, only one version is the most up-to-date and correct. Each time a block is written to the passed ledger 240, the passed ledger 240 is not updated; rather, a new passed ledger 240 is created. For example, if the passed ledger 240 has nine blocks and a new tenth block is added to the end of the passed ledger 240, you can still prove that first nine blocks of the ten blocks are correct. However, if you examine the hash ledger 242, it has a tenth hash and some other participant has permission to write to the passed ledger, so you know that the old passed ledger 240 is no longer the most up-to-date. The passed ledger 240 is a global ledger that has information about ownership and history of the object over time. The hash ledger 242 is held or owned by the object creator. The owner of the passed ledger 240 is simply the only one who has the correct permissions to append to the hash ledger 242. Each time they append, they include the most recent accepted hash, and update the permissions as to who may append next. The change of ownership information and information about characteristics of the object would be communicated to the passed ledger 240.

At step 248, ownership information for the object is defined and the hash ledger 242 is created. A hash of the contents of the passed ledger 240 is generated and transmitted to the hash ledger 242. The hash ledger 242 is stored at the highest level that it can be used across. For example, if an asset may be used across a genre of games, it is stored at the level where licenses for those games are stored or located. If the asset is valid across a platform, the asset would be held at the level of the platform. Examples include the asset being held by Microsoft Corp. for X-Box® games. Optionally, at step 250, the hash ledger may be copied to or stored at a device of the user 244. For example, in FIG. 2A, if the user 244 accesses the AR engine 202 using the portable device 212, a copy of the hash ledger 242 may be communicated over communication network 214 to the portable device 212.

At step 252, the user 244 begins immersion with the object. Details of such immersion will depend on the context. For example, in the context of a virtual reality game, the user may begin interacting, using his remote device, with other players in the virtual reality game and with objects in the virtual reality game. The virtual reality game is controlled by the AR engine 202 operating in conjunction with the remote device of the user 244. In the context of a factory, where the object is a component or a tool, the user may operate on the object or use the object as a tool on another object. The passed ledger 240 will be written with blocks containing details of the use of the object, modifications to the object such as wear or degradation, etc.

At step 254, when the user operating a user device requests to take possession of an object outside of the gaming environment, the user device writes to the passed ledger 240 a block, as proposed by the AR engine, indicating the desire to check out the object. The AR engine 202 accepts the new block and that the user has checked out the object and writes to the passed ledger 240 a block with that information. Such a check out corresponds to the user taking possession or ownership of the object. Reporting check-out to the hash ledger 242 by the AR engine 202 can be done by the AR engine 202 writing a hash of the passed ledger 240 to the hash ledger 242. In some embodiments, whenever there is a change of ownership or possession of an object, a block is written to the passed ledger 240 and a hash of the passed ledger 240 is written to the hash ledger.

Whenever a block is written in the passed ledger 240, a hash of the same block is written to the hash ledger 242. Also, the permissions of the hash ledger are updated. Thus, when a participant such as the user 244 is checking an object into the game, the user 244 gives the AR engine 202 permission to make a next update to the hash ledger 242. Then when a block is written to the hash ledger 242, the specific information written in the block to the hash ledger 242 is dependent on the object and the virtual reality game or other virtual environment. In some examples, the written information includes status information such as a relative strength of a game piece such as the sword 228 or a notation that the object was damaged. The information may also include a time stamp for the current time, identification information of the current owner or possessor of the item,

In another example, if the object was lost or dropped by a user such as user 244 in the game, the AR engine 202 might write a block with information recording that the AR engine has taken possession of the object, followed by a block recording the location where the object was dropped and a subsequent block recording another user up picked up the object and took possession of the object.

Each of those actions or activities may be written to the hash ledger 242 as a unique block. Further, each of those actions or activities may be something another user or the AR engine 202 may wish to verify in the future. For example, a future purchaser or acquirer of the object may wish to verify some characteristic of the object or some aspect of its history, such as that the sword 228 retains 60% of its power, or that it really was used as represented to achieve some accomplishment.

The passed ledger 240 may become a relatively large file storing a substantial amount of data. The hash ledger 242 stores just the resulting hash of the contents of the passed ledger 240. In this manner, several substantial technological advantages may be realized in a system and method. For example, the processing requirements and data storage requirements of the system implementing the AR environment are reduced. The hash ledger 242 is generally much smaller in size than the passed ledger and requires less memory to store. Communicating hash values from the user device that has possession of the object and writes to the passed ledger requires less communication bandwidth than passing the entire passed ledger would require. Moreover, only the passed ledger contains all details of the history of the object, improving security and privacy of the transactions and actions upon the object.

Any suitable hashing algorithm may be selected for generating the hash of the contents of the passed ledger 240 and providing the hash to the hash ledger. For example, some hash algorithms produce just a single character hash. Other hash algorithms produce a 64-character hash. The selection of hash algorithm may be made based on factors such as the level of security desired. For example, in a large scale virtual reality game with many participants where risk of fraud may be elevated, a higher-security hash algorithm may be selected. The higher-security hash algorithm may have associated costs, though, such as requiring more time to complete, more memory for data storage, and greater computational-complexity. In contrast, in an XR setting for a factory application, where the system operates to track location of an object and its characteristics, the need for security may not be as high, so a faster, less computationally-intensive hash algorithm may be selected.

At step 256, a passing back and forth of the block occurs. The user 244 determines to take an object such as the sword 228 out of inventory and put the object into the game. At step 254, the user 244 creates a block expressing that desire and communicates that block to the AR engine 202. The AR engine 202 receives that block and completes the block with information that indicates the user 244 has checked-in the object, sword 228, and given the AR engine 202 permission to update the status of the object. The AR engine 202 at step 256 receives confirmation that it has control of the object. The user 244 submits the block to the passed ledger 240 and the resulting hash to the hash ledger. The object then is owned by the AR engine 202 which then uses the object in the course of the game. In some embodiments, a hash lock is put in place at step 256 where the write permissions of the hash ledger 242 are updated such that only the AR engine 202 has permission to write updates. Under the condition of the hash lock, the AR engine 202 is then the only party able to make a next update to the object. Other participants, including user 244, and remote devices associated with other participants, are blocked from writing to the passed ledger.

At step 260, information about the object is updated during the game as determined by the AR engine 202. For example, in the case of sword 228, if the sword becomes diminished in power, that condition is updated by the AR engine 202 writing an additional block to the passed ledger 240. If the sword 228 is dropped, that condition is updated by the AR engine 202 writing an additional block to the passed ledger 240. If another player picks up the sword 228, that condition is updated by the AR engine 202 writing an additional block to the passed ledger 240 and, due to the change of ownership, the hash of the passed ledger is written to the hash ledger.

At step 262 and step 264, optional read-only access may be available in some embodiments. Generally, only the AR engine 202 can update the properties of an object by writing a block to the passed ledger 240. Further, in general, the detailed contents of the passed ledger 240 are not accessible by participants who do not have current ownership of the object. This general rule provides a heightened degree of security to the information contained in the passed ledger 240. However, it may be desirable to give other participants in the virtual environment the ability access the passed ledger 240, step 268, to read the contents of the passed ledger 240. That may be valuable in some applications such as advertising an asset for sale or trade. The optional operations of steps 262, 264 make that possible.

While in the hash lock state established at step 256, the AR engine 202 can still push data to the passed ledger, step 266 and step 268. The AR engine 202 can write to the passed ledger as it needs to, based on activities in the virtual environment. However, during the hash lock condition, other participants can only read in this example, optional, embodiment. During this time, the AR engine 202 is the owner of the asset and hence the correct version of the passed ledger. The AR engine 202 may share the contents with a participant in possession of the object, or with others within the game. For example, if a selected participant upgrades his avatar, that upgrade should be visible to those other participants that encounter the selected participant.

At step 270, the user 244 indicates that the user desires to check in the object, such as sword 228, which was checked out at step 254. This may occur, for example, because the user is done playing the game and wants to save progress and the game state and check objects or items back into the personal inventory of the user 244. The AR engine 202 presents to the user 244 the blocks corresponding to the objects including the sword 228 and the user 244 verifies that the data in the blocks is correct by writing an additional block to the passed ledger. At that point, the user 244 updates the passed ledger 240 and therefore possesses the passed ledger 240. The AR engine 202 updates the hash ledger 242 after the user 244 completed the block to tell the AR engine 202 what the correct hash is to report to the hash ledger 242.

At step 272, the object is sold or transferred between users. The object is checked out, step 274, by the AR engine 202, giving the AR engine 202 ownership of the object and the ability to update information about the object. A copy of the ledger entries of the passed ledger 240 is exchanged between the selling user 244 and the acquiring user, step 276. At step 278, a block reflecting the change in ownership is written by the AR engine 202 to the passed ledger 240. At block 280, the AR engine 202 checks in the transferred object and writes a block to the passed ledger 240, and the object becomes part of the inventory of the acquiring user. At step 282, the change in ownership is reported to the selling user 244 and the acquiring user. In some embodiments, the sale or transaction may occur outside of the AR engine 202, between participants. In such an example, the individuals may update the passed ledger 240 and the hash ledger 242 showing the new owner information.

FIG. 2D is an illustrative embodiment of a cryptographic ledger system including a passed ledger 240 and an associated hash ledger 242 in accordance with various aspects described herein. Every object in an AR environment, or every object of interest, has an associated passed ledger such as the passed ledger 240. The passed ledger 240 includes a chain or set of individual blocks. In the example of FIG. 2D, the passed ledger 240 include block N 284 and block N+1 286. Each time an activity or event occurs to the object associated with the passed ledger 240, a new block is written to the passed ledger 240. The new block is appended to the existing N+1 blocks in the passed ledger 240. In an example, if the passed ledger 240 is associated with a sword such as sword 228 in an AR game, when the sword is picked up, a block is written to the passed ledger 240. When the sword is used, causing its capabilities to change, a block is written to the passed ledger 240. The passed ledger 240 thus includes a file stored in memory containing data that define the object associated with the passed ledger and data defining the history of the object. The data in the file are arranged as a concatenation of blocks including block N 284 and block N+1 286. Each block is written with suitable data, including data defining location, characteristics and ownership of the object, data defining a change to any of the location, characteristics or ownership of the object, timestamp data and any other data appropriate for the object, the environment or the situation. The passed ledger 240 maintains a full record of the history of the associated object over time. The passed ledger 240 may be stored in any suitable memory storage location. In some embodiments, the passed ledger 240 may be communicated among participants in the AR environment when the object associated with the passed ledger is sold or transferred among the participants, or when possession of the associated object is changed.

The hash ledger 242 contains a string of hash values 288. Each hash value is associated with a block of the passed ledger 240. Thus, hash ledger 242 in the example includes values for Block 0 hash, Block 1 hash, Block 2 hash, up to and including values for Block N hash and Block N+1 hash. These are illustrated in FIG. 2D. Any suitable hashing algorithm may be used to generate the hash valued.

The passed ledger 240 can be used in conjunction with an object in an AR environment by a participant in the AR environment. In one example, the passed ledger 240 is associated with a tool such as a screwdriver in an AR environment corresponding to a factory. If a participant in the AR environment, such as a factory worker, requires use of the tool, the participant does not need to check a space or location where the tool might be or should be located. Rather, the participant submits a request 290 for the tool. The request 290 may be submitted in any suitable fashion, such as through a user interface on a remote device such as one of the remote devices 204 of FIG. 2A. More specifically, the participant requests the most recent passed ledger 240 for the tool. The device of the user, or the AR engine, mines the block and reports on the status of the tool. The status may be contained in one or more blocks 284, 286 of the passed ledger 240. If the tool is checked in to the AR engine, the participant will be able to see the passed ledger 240 and learn if the tool exists and where it is located. If the tool is not checked in to the AR engine, but rather is in use in the game, status 292, the tool may be locked out and unavailable to the participant. Moreover, if the tool is not checked in to the AR engine, no other information may be provided to the participant in some embodiments where security and protection from fraud are particularly important.

In response to the request 290, possession of the tool is transferred to the participant. This is reflected in block N+1 286, which is written to the passed ledger 240. Block N+1 286 includes a status 294 reflecting that the tool is being checked out and recording the status of the tool, including its condition and any other characteristics that may be of interest. Block N+1 further reflects the location 296 of the tool and the transfer of ownership to the participant.

The paradigm of the split ledger, including the passed ledger and the hash ledger may be extended to other use cases as well. In a first exemplary use case, the passed ledger may be used to track a virtual object among different AR environments and maintain permanence for the object in the different environments. For example, an online system provider may provide access to multiple online AR video games. An object, such as the sword 228 of FIG. 2B, may be characterized by a passed ledger and the passed ledger belongs to the online system provider. The passed ledger may be made available to multiple AR video games so that the characteristics of the sword as modified by a first game are maintained if the sword is used in a second game. A hash ledger or split ledger is associated with each respective AR game of the multiple AR games. For example, if the sword is diminished in strength in the first game, if it is used in the second game by the same or another user, it will continue to have the same diminished strength unless altered in the second game.

In a second use case, the passed ledger may be used to maintain AR persistence for actions in an AR room. In this example, an AR world includes several AR rooms. The hash ledger or split ledger belongs to just one particular AR room of the AR world. The hash ledger records all the actions that happen in that AR room. For example, if the AR room includes walls, each respective wall has an associated passed ledger. Activities and interactions with a respective wall are recorded in the passed ledger for the wall and reflected in the hash ledger for the particular AR room. However, other AR rooms are not interested in what happens in the particular AR room, so the hash ledger is not shared with other AR rooms of the AR world.

In a third use case, in an education context, a passed ledger is associated with aspects of a university registrar's office. A passed ledger may be associated with each course and record information about students in the course grades in the course. The associated hash ledger or split ledger may be associated with the ownership of each respective course and would store information such as test scores and quiz scores in the course. However, the university registrar does not care about individual assignments, tests and quizzes in a course, so those are not shared with the registrar through the passed ledger.

In a fourth use case, in the context of supply chain tracking, an original container stores a set of components, and the passed ledger is associated with the container and the components. A split ledger or hash ledger stores information about the components.

These ideas and concepts may be extended to the widest variety of environments, including other augmented reality, virtual reality and XR environments.

While for purposes of simplicity of explanation, the respective processes are shown and described as a series of blocks in FIGS. 2A, 2B, 2C and 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

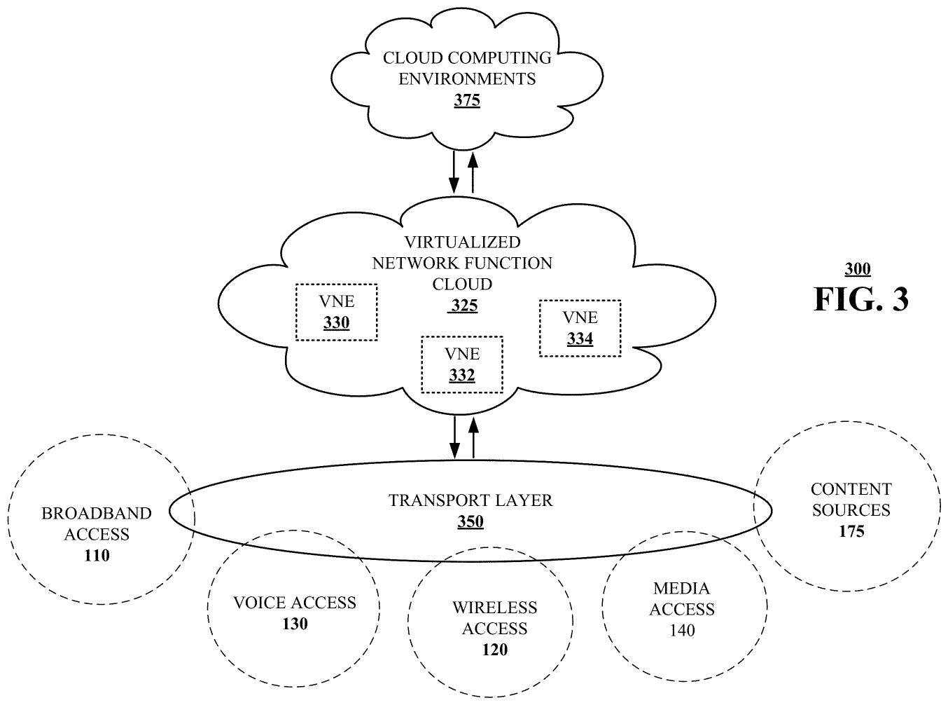

Referring now to FIG. 3, a block diagram of a communication network 300 is shown illustrating an example, non-limiting embodiment of a virtualized communication network in accordance with various aspects described herein. In particular, a virtualized communication network is presented that can be used to implement some or all of the subsystems and functions of system 100, the subsystems and functions of AR system 200, and method 238 presented in FIGS. 1, 2A, 2B, 2C, 2D, and 3. For example, virtualized communication network 300 can facilitate in whole or in part an augmented reality system including a server at a network element and accessible by remote devices at other network elements. The augmented reality system associates a passed ledger with an object and records blocks of information about events of the object in the passed ledger. At times, a hash is made of the data in the passed ledger and communicated to remote devices participating in the augmented reality system.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

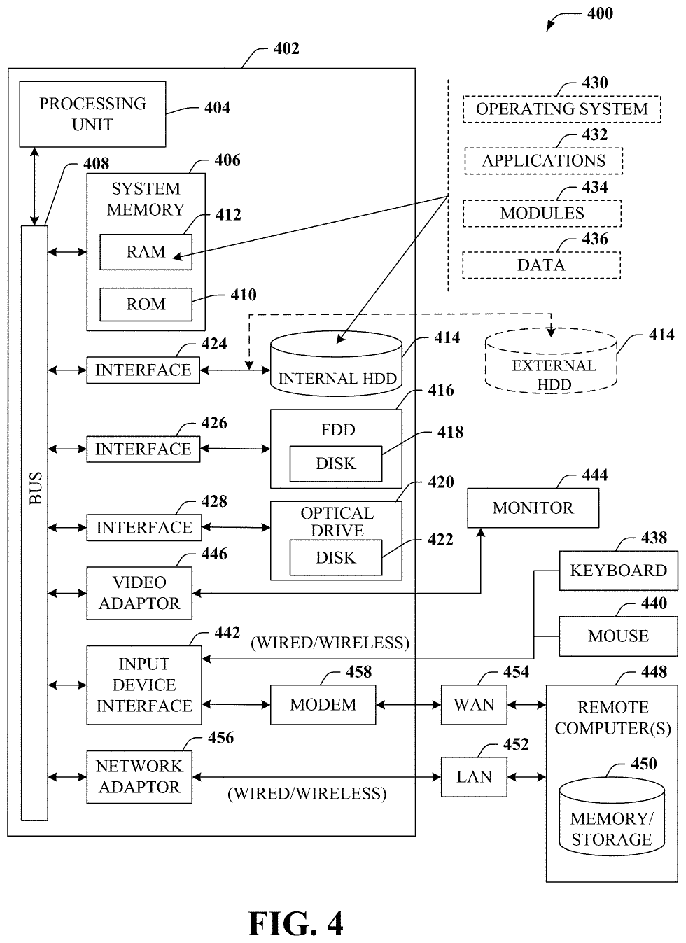

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part an augmented reality system including a server embodied as the computing environment at a network element and accessible by remote devices at other network elements which may also be embodied as the computing environment 400. The augmented reality system associates a passed ledger with an object and records blocks of information about events of the object in the passed ledger. At times, a hash is made of the data in the passed ledger and communicated to remote devices participating in the augmented reality system.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in other embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

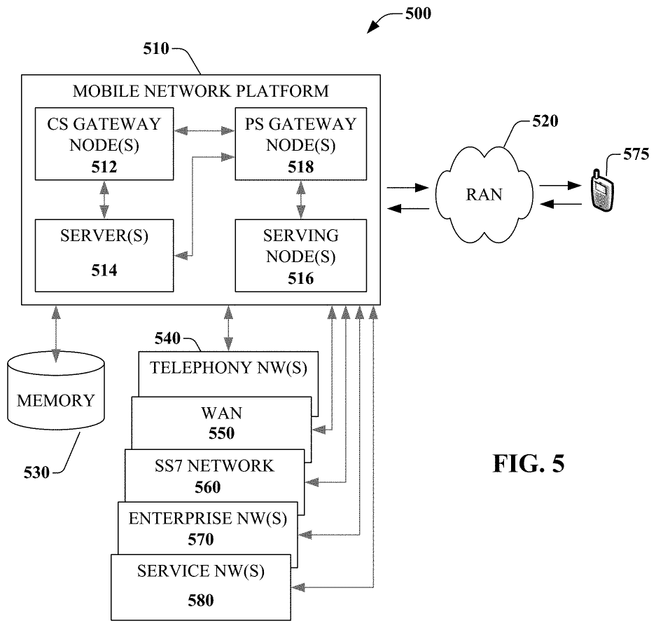

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part communication in an augmented reality system which includes a server at a network element and accessible by remoted devices at other network elements. The augmented reality system associates a passed ledger with an object and records blocks of information about events of the object in the passed ledger. At times, a hash is made of the data in the passed ledger and communicated to remote devices participating in the augmented reality system. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by a radio technology or radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

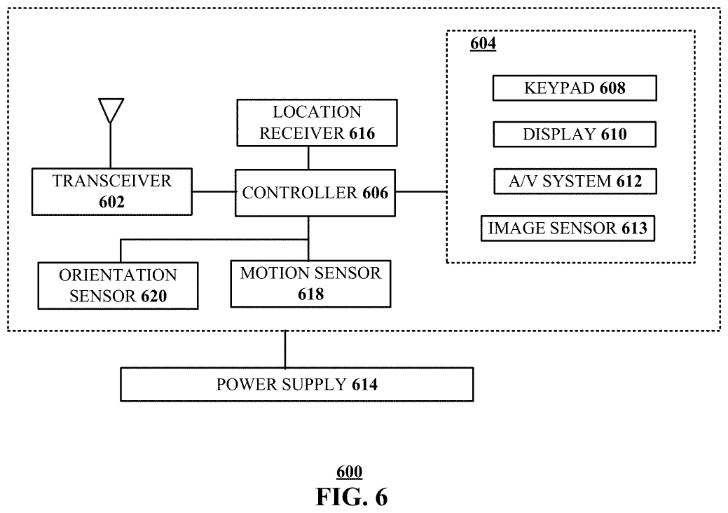

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part an augmented reality system including a server at a network element including an embodiment of computing device 600 and accessible by remoted devices at other network elements which also include embodiments of computing device 600. The augmented reality system associates a passed ledger with an object and records blocks of information about events of the object in the passed ledger. At times, a hash is made of the data in the passed ledger and communicated to remote devices participating in the augmented reality system.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
implementing, by the processing system, an augmented reality system, wherein the augmented reality system is accessible by participants using a plurality of user devices;
storing, in the memory, a passed ledger, the passed ledger comprising data associated with characteristics of a virtual object in the augmented reality system;
receiving, at the processing system, information about a change to a characteristic of the virtual object;
writing, to the passed ledger, a block of data, wherein the block of data is based on the change to the characteristic of the virtual object;
generating, responsive to the writing, a hash of contents of the passed ledger;
storing, in the memory, the hash of the contents of the passed ledger in a hash ledger; and
communicating the hash of the contents of the passed ledger to a remote device.

2. The device of claim 1, wherein the operations further comprise:
receiving information about a change in possession of the virtual object; and
writing, to the passed ledger, a new block of data, wherein the new block of data records the change in possession of the virtual object,
wherein the communicating the hash of the contents of the passed ledger is responsive to the change in possession of the virtual object.

3. The device of claim 1, wherein the storing the passed ledger comprises:
storing, in the memory, information about one or more characteristics of the virtual object;
storing, in the memory, information about a location of the virtual object; and
storing, in the memory, information about possession of the virtual object, wherein possession of the virtual object comprises an association with a selected user device of the plurality of user devices.

4. The device of claim 1, wherein the communicating the hash of the contents of the passed ledger comprises communicating the hash of the contents of the passed ledger to each user device of the plurality of user devices.

5. The device of claim 1, wherein the operations further comprise:
receiving, from a user device of the plurality of user devices, a request to use the virtual object;
writing, to the passed ledger, a new block of data, the new block of data comprising information about the user device and information permitting the processing system to update status of the virtual object;
generating a new hash of the contents of the passed ledger including the new block of data; and
communicating the new hash of the contents of the passed ledger to each user device of the plurality of user devices.

6. The device of claim 5, wherein the operations further comprise:
imposing a hash lock so that only a participant in the augmented reality system having possession of the virtual object may access the passed ledger, to thereby maintain privacy and security of the contents of the passed ledger.

7. The device of claim 6, wherein the operations further comprise:
providing read-only access to the contents of the passed ledger for some or all participants in the augmented reality system.

8. The device of claim 1, wherein the operations further comprise:
creating, by the augmented reality system, a first augmented reality environment and a second augmented reality environment, wherein the second augmented reality environment is independent of the first augmented reality environment; and
sharing the virtual object, including the passed ledger associated with the virtual object, between the first augmented reality environment and the second augmented reality environment, wherein the sharing comprises maintaining permanence of the virtual object among the first augmented reality environment and the second augmented reality environment.

9. The device of claim 8, wherein the operations further comprise:
transferring history of the virtual object from the first augmented reality environment to the second augmented reality environment.

10. The device of claim 8, wherein the operations further comprise:
tracking, by the processing system, location of one or more real-word object in the augmented reality system.

11. A machine-readable medium, comprising executable instructions that, when executed by a processing system including a processor of a server system, facilitate performance of operations, the operations comprising:
establishing an augmented reality environment in the server system, wherein the server system is accessible by a plurality of remote devices of participants in the augmented reality environment;
creating a virtual object in the augmented reality environment, wherein the creating the virtual object comprises assigning to the virtual object a plurality of characteristics, a location and ownership;
creating for the virtual object a passed ledger, wherein the passed ledger is configured to store data associated with the characteristics, the location and the ownership of the virtual object;
receiving, by the server system, an indication of a modification to one of a characteristic, the location and the ownership of the virtual object;
writing, by the server system to the passed ledger, a block of data, wherein the block of data is based on a change to the characteristic, the location or the ownership of the virtual object; and
communicating, by the server system, a hash of contents of the passed ledger to remote devices of the plurality of remote devices to inform the remote devices about the change to the characteristic, the location or the ownership without communicating the passed ledger.

12. The machine-readable medium of claim 11, wherein the operations further comprise:
creating, within the augmented reality environment, a first virtual environment and a second virtual environment;
receiving an indication of a movement of the location of the virtual object from the first virtual environment to the second virtual environment;
writing, to the passed ledger, a new block of data, the new block of data comprising information about the movement of the location of the virtual object from the first virtual environment to the second virtual environment;
subsequently, receiving an indication of a further modification to one of a characteristic, the location and the ownership of the virtual object in the second virtual environment; and
writing, to the passed ledger, a further block of data, wherein the further block of data is based on the further modification to the characteristic, the location or the ownership of the virtual object in the second virtual environment.

13. The machine-readable medium of claim 11, wherein the operations further comprise:
creating, within the augmented reality environment, a first virtual environment on a first gaming platform;
creating, within the augmented reality environment, a second virtual environment on a second gaming platform; and
writing, to the passed ledger, a new block of data, the new block of data comprising information about movement of the location of the virtual object from the first virtual environment to the second virtual environment.

14. The machine-readable medium of claim 11, wherein the operations further comprise:
receiving an indication of a change in possession of the virtual object;
writing, to the passed ledger, a new block of data, wherein the new block of data comprises information about the change in possession of the virtual object;
generating a hash of contents of the passed ledger; and
communicating the hash of the contents of the passed ledger to other devices of the plurality of remote devices of participants in the augmented reality environment.

15. The machine-readable medium of claim 14, wherein the operations further comprise:
establishing a hash lock on the passed ledger, the hash lock enabling only a participant in the augmented reality environment having possession of the virtual object to access the passed ledger, to thereby maintain privacy and security of the contents of the passed ledger.

16. The machine-readable medium of claim 15, wherein the operations further comprise:
providing read-only access to the contents of the passed ledger for selected participants in the augmented reality environment.

17. A method, comprising:
establishing, by a processing system including a processor and a memory, an augmented reality environment, wherein the processing system is accessible over a communication network by a plurality of remote devices of participants in the augmented reality environment;
creating, by the processing system, a virtual object in the augmented reality environment, wherein the creating the virtual object comprises assigning to the virtual object a plurality of characteristics;
storing, by the processing system, data in a passed ledger in the memory forming stored data, wherein the stored data is associated with at least one characteristic of the plurality of characteristics of the virtual object;
receiving, by the processing system, a communication over the communication network from a remote device of the plurality of remote devices, the communication including information about a modification to the at least one characteristic the virtual object;
writing, by the processing system to the passed ledger, a block of data, wherein the block of data is based on the modification to the at least one characteristic of the virtual object;
generating, by the processing system, a hash of contents of the passed ledger; and
communicating, by the processing system, the hash of the contents of the passed ledger to the plurality of remote devices to inform the plurality of remote devices about the modification to the at least one characteristic without communicating the passed ledger.

18. The method of claim 17, comprising:
creating, by the processing system, within the augmented reality environment, a first virtual environment and a second virtual environment;
receiving, by the processing system, an indication of a movement of a location of the virtual object from the first virtual environment to the second virtual environment; and
writing, by the processing system, to the passed ledger, a new block of data, wherein the writing the new block of data comprises writing information to the passed ledger about the movement of the location of the virtual object from the first virtual environment to the second virtual environment.

19. The method of claim 18, wherein creating the first virtual environment and the second virtual environment comprises:
creating, by the processing system, the first virtual environment on a first gaming platform; and
creating, by the processing system, the second virtual environment on a second gaming platform, wherein the first gaming platform and the second gaming platform are independent gaming platforms.

20. The method of claim 17, further comprising:
limiting, by the processing system, write access to the passed ledger to only a participant in the augmented reality environment who has possession of the virtual object.
